(19) United States
(12) Patent Application Publication
(10) Pub. No.: US 2018/0253417 A1
(43) Pub. Date: Sep. 6, 2018

(54) INFORMATION PROCESSING DEVICE AND NON-TRANSITORY COMPUTER READABLE MEDIUM

(71) Applicant: FUJI XEROX CO., LTD., Tokyo (JP)

(72) Inventors: Kazuya TANAKA, Kanagawa (JP); Yusuke TAMURA, Kanagawa (JP); Yasuhiro ITO, Kanagawa (JP)

(73) Assignee: FUJI XEROX CO., LTD., Tokyo (JP)

(21) Appl. No.: 15/701,788

(22) Filed: Sep. 12, 2017

(30) Foreign Application Priority Data
Mar. 6, 2017 (JP) 2017-041259

(51) Int. Cl. G06F 17/27; G06K 9/72; G06F 17/28

(52) U.S. Cl. CPC G06F 17/274; G06F 17/289; G06K 9/726

(57) ABSTRACT

An information processing device includes a receiving unit, an acquiring unit, and a replacing unit. The receiving unit receives a sentence containing at least a proper noun. The acquiring unit acquires information related to a user who uses a sentence processed by the information processing device. The replacing unit replaces the proper noun with another noun by using the information related to the user.

### CROSS-REFERENCE TO RELATED APPLICATIONS

This application is based on and claims priority under 35 USC 119 from Japanese Patent Application No. 2017-041259 filed Mar. 6, 2017.

### BACKGROUND

The present invention relates to an information processing device and a non-transitory computer readable medium.

### SUMMARY

According to an aspect of the invention, there is provided an information processing device including a receiving unit, an acquiring unit, and a replacing unit. The receiving unit receives a sentence containing at least a proper noun. The acquiring unit acquires information related to a user who uses a sentence processed by the information processing device. The replacing unit replaces the proper noun with another noun by using the information related to the user.

### BRIEF DESCRIPTION OF THE DRAWINGS

Exemplary embodiments of the present invention will be described in detail based on the following figures, wherein:

FIG. 1 is a conceptual module configuration diagram of a configuration example of a first exemplary embodiment;

FIG. 2 is an explanatory diagram illustrating a system configuration example using the exemplary embodiment;

FIG. 3 is a flowchart illustrating a process example of the first exemplary embodiment;

FIG. 4 is an explanatory diagram illustrating a data structure example of a proper noun pair table;

FIG. 5 is an explanatory diagram illustrating a data structure example of a profile table;

FIG. 6 is an explanatory diagram illustrating a process example of the first exemplary embodiment;

FIG. 7 is an explanatory diagram illustrating a data structure example of a proper noun pair and attribute table;

FIG. 8 is an explanatory diagram illustrating a data structure example of a category tree;

FIG. 9 is an explanatory diagram illustrating a data structure example of a proper noun profile table;

FIGS. 10A and 10B are explanatory diagrams illustrating a data structure example of a user profile table;

FIG. 11 is an explanatory diagram illustrating a process example of the first exemplary embodiment;

FIG. 12 is a conceptual module configuration diagram of a configuration example of a second exemplary embodiment;

FIG. 13 is an explanatory diagram illustrating a process example of the second exemplary embodiment; and

FIG. 14 is a block diagram illustrating a hardware configuration example of a computer implementing the exemplary embodiments.

### DETAILED DESCRIPTION

Various examples of exemplary embodiments for implementing the present invention will be described below based on the drawings.

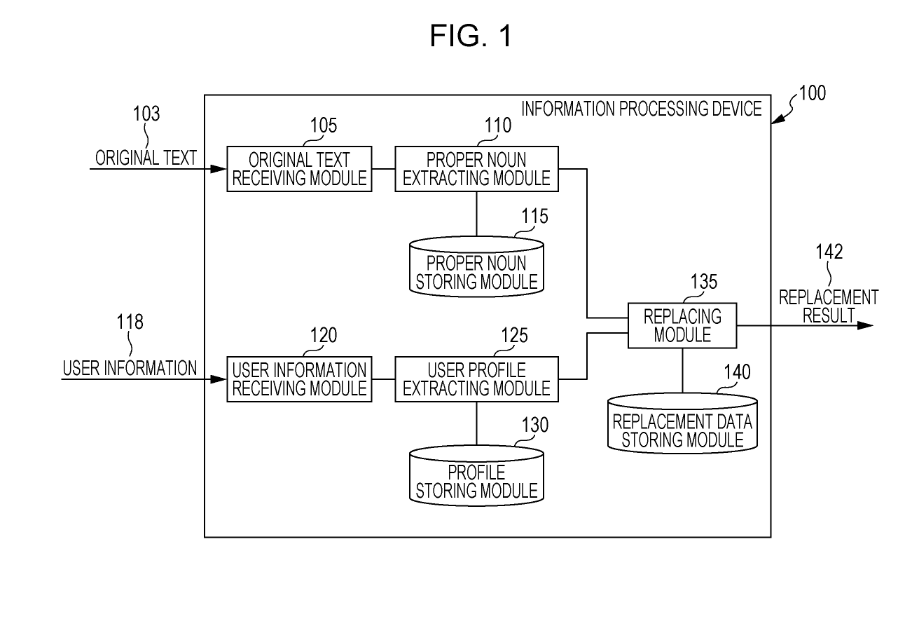

FIG. 1 is a conceptual module configuration diagram of a configuration example of a first exemplary embodiment.

The term “module” generally refers to a component of logically separable software (a computer program) or hardware, for example. In the exemplary embodiment, therefore, the term “module” refers not only to a module of a computer program but also to a module of a hardware configuration. The description of the exemplary embodiment will thus cover a computer program (a program for causing a computer to execute respective procedures, a program for causing a computer to function as respective units, or a program for causing a computer to realize respective functions), a system, and a method for causing a computer to function as such modules. For the convenience of description, terms “to store (something)” and “to cause (an object) to store (something)” and equivalents thereof will be used. If an exemplary embodiment is implemented as a computer program, these terms mean “to cause or control a storage device to store (something).” Further, the modules may correspond one-to-one to the functions. In implementation, one module may be configured by one program, or plural modules may be configured by one program. Conversely, one module may be configured by plural programs. Further, plural modules may be executed by one computer, or one module may be executed by plural computers in a distributed or parallel environment. One module may include another module. Further, the term “connect” will hereinafter be used to refer not only to physical connection but also to logical connection (such as exchange of data, transmission of instructions, and reference between data). The term “predetermined” means that something is determined before a target process, and the term will be used to also mean that something is determined in accordance with the current or past condition or state not only before the start of processes of the exemplary embodiment but also after the start of the processes of the exemplary embodiment and before the target process. If there are plural “predetermined values,” the values may be different from one another, or two or more of the values (which obviously include all of the values) may be the same. Further, a description “If A is true, B is performed” will be used to mean that “whether or not A is true is determined, and B is performed if it is determined that A is true,” except when the determination of whether or not A is true is unnecessary. Further, a listing of items, such as “A, B, and C,” will be understood as a listing of examples unless otherwise noted, and the examples include a case in which only one of the items (only A, for example) is selected.

Further, the term “system” or “apparatus” refers to a configuration in which plural computers, hardware components, devices, or the like are connected by a communication unit such as a network (including one-to-one communication connection) and also a configuration implemented by one computer, hardware component, device, or the like. The terms “apparatus” and “system” will be used synonymously. Needless to say, the term “system” excludes a mere social “structure” (social system) arranged by humans.

Further, for each process performed by each module, or for each of plural processes performed in the module, target information is read from a storage device, the process is performed, and thereafter the result of the process is written to the storage device. Therefore, description of reading from the storage device before the process and writing to the storage device after the process may be omitted. Herein, the storage device may be a hard disk, a random access memory (RAM), an external storage medium, a storage device via a communication line, or a register in a central processing unit (CPU), for example.

An information processing device 100 of the first exemplary embodiment replaces a proper noun in an original text 103 with another noun. As illustrated in the example of FIG. 1, the information processing device 100 includes an original text receiving module 105, a proper noun extracting module 110, a proper noun storing module 115, a user information receiving module 120, a user profile extracting module 125, a profile storing module 130, a replacing module 135, and a replacement data storing module 140.

The original text receiving module 105, which is connected to the proper noun extracting module 110, receives the original text 103. The original text receiving module 105 receives the original text 103 containing at least a proper noun. Receiving the original text 103 includes receiving the original text 103 created with a device such as a keyboard, for example, receiving the original text 103 from an external device via a communication line, and reading the original text 103 stored in a hard disk (built in the information processing device 100 or connected to the information processing device 100 via a network, for example) or the like. The language of the original text 103 may be any language, such as Japanese, English, or Chinese. The original text 103 contains at least a proper noun, which may be the name of a country, place, or person, the name of a work, such as the title of a book, song, or movie, or the name of a group, building, brand, or star, for example.

The proper noun storing module 115, which is connected to the proper noun extracting module 110, stores proper nouns. For example, the proper noun storing module 115 may include a dictionary containing combinations of words and parts of speech.

The proper noun extracting module 110 is connected to the original text receiving module 105, the proper noun storing module 115, and the replacing module 135. With information in the proper noun storing module 115, the proper noun extracting module 110 extracts a proper noun from the original text 103 received by the original text receiving module 105. A technique such as morpheme analysis, for example, may be employed therefor.

The user information receiving module 120, which is connected to the user profile extracting module 125, receives user information 118. Receiving the user information 118 includes receiving the user information 118 based on a user identification (ID), a password, and fingerprint authentication through an operation performed by a user on a device such as a keyboard, for example, receiving the user information 118 from an external device via a communication line, and reading the user information 118 stored in a hard disk or the like.

The profile storing module 130, which is connected to the user profile extracting module 125, stores information related to the user. The “information related to the user,” which is also called a profile, is an information list of attributes related to the target user. Specific examples of the “information related to the user” include name, age, sex, birth date, country of origin (nationality), place of origin, language used, current address, occupation, field of business, and hobbies.

The user profile extracting module 125 is connected to the user information receiving module 120, the profile storing module 130, and the replacing module 135. The user profile extracting module 125 acquires from the profile storing module 130 the information related to the user who uses a sentence processed by the information processing device 100 (a replacement result 142). Herein, the “user who uses a sentence” is a person who directly or indirectly uses the sentence a part of which is replaced (the processed sentence according to the exemplary embodiment). The person who directly uses the sentence is a reader of the replaced sentence, and the person who indirectly uses the sentence is a reader of a sentence obtained by performing a further process (such as translation) on the replaced sentence.

The replacement data storing module 140, which is connected to the replacing module 135, stores pairs of proper nouns and nouns, which are replacement sources and replacement targets, respectively. The replacement data storing module 140 may further store information related to the proper nouns and information related to the nouns. The information related to a proper noun or the information related to a noun includes, for example, the location, uses, and language of the building or the like represented by the proper noun (noun). Further, the replacement target nouns may be assigned with priority levels in accordance with the profile of the user, and the noun to replace a proper noun may be determined in accordance with the priority levels. Further, the replacement data storing module 140 may be expressed as a category tree in which the proper nouns, the nouns, and the information related to the user are stored in association with one another.

The replacing module 135, which is connected to the proper noun extracting module 110, the user profile extracting module 125, and the replacement data storing module 140, outputs the replacement result 142. With the replacement data storing module 140 and the information related to the user acquired by the user profile extracting module 125, the replacing module 135 replaces the proper noun extracted by the proper noun extracting module 110 with another noun. Herein, the “another noun” is a noun easily understood by the user and based on the information (background) related to the user. The “another noun,” which is a noun different from the proper noun in a target sentence, naturally includes a proper noun. For example, a proper noun “Mount Fuji” (3776 meters above sea level) contained in the target sentence may be replaced by a proper noun “Mount Forel” (a mountain in Greenland, approximately 3360 meters above sea level) as “another noun.”

Further, the replacing module 135 may select another noun to replace a proper noun in accordance with the language used by the user. Further, if such a selection is performed, the replacing module 135 replaces the proper noun extracted by the proper noun extracting module 110 with the selected “another noun.”

Further, the replacing module 135 may replace a proper noun with another noun by using the replacement data storing module 140, in which the proper nouns, the nouns, and the information related to the user are stored in association with one another. For example, if information items in the replacement data storing module 140 are assigned with priority levels, as descried above, it is possible to select a proper noun that creates an impression on the user.

Further, the replacing module 135 may replace a proper noun with another noun by comparing the information related to the user with information related to a noun similar to the proper noun. For example, the replacing module 135 may use the above-described category tree, which enables replacement according to the profile of the user.

Further, the replacing module 135 may change a noun into a currently used noun. Herein, the “currently used noun” may be obtained from a latest glossary retrieved through search on the Internet or from a revised version of an electronic dictionary when a revision is made thereto, for example. A noun (including a proper noun) is updated in accordance with a so-called trend. Such updating includes deleting the name of a building or another item that no longer exists, rewriting a renamed item, and changing a noun into a more frequently used noun, for example. With this update, the noun is kept easy to understand for the user.

The above-described “proper noun” may be a combination of a proper noun and a quantitative expression located near the proper noun. Herein, the “combination of a proper noun and a quantitative expression located near the proper noun” has (1) the proper noun followed by the quantitative expression, or (2) the quantitative expression preceding the proper noun. Examples of the former include “Oedo Dome×10”, and examples of the latter include “10 Oedo Domes.” Further, the term “near” means that the quantitative expression is adjacent to (immediately preceding or following) the proper noun, or that the proper noun and the quantitative expression are separated from each other by a predetermined number of characters (three characters, for example). The quantitative expression may be obtained by extracting, by a method such as pattern matching, a character string formed of a character string representing a numeric value (an Arabic numeral such as 1, 2, or 3, a Chinese numeral for 1, 2, or 3, or a numeric character string such as “half” or “double,” for example) and a unit.

The “combination of a proper noun and a quantitative expression” will be described in more detail. The following description intends to facilitate the understanding of the exemplary embodiment.

The information processing device 100 specifically rephrases a quantitative expression to suit the user. Adding a supplemental description (supplemental information) to a proper noun may help the user to underhand the proper noun. Mere supplemental description of the proper noun, however, simply provides understanding of an absolute size represented by a numeric value.

An item unfamiliar to the user is difficult for the user to get an idea thereof from the supplemental description alone, and thus should be replaced by an item familiar to the user. In particular, the “combination of a proper noun and a quantitative expression” is a relative or emotive (experiential based on experiences of a writer) expression of a quantity based on knowledge and experience of the writer. For example, if a proper noun “Oedo Dome” is added with a supplemental description that the dome is a “baseball stadium,” the size of the baseball stadium imagined by an American from a country where baseball is popular would be different from that imagined by a British person from a country where baseball is less popular. Further, if an expression is based on an item peculiar to a specific region, such as “the same size as that of Hokkaido,” simply adding a supplemental description “380,000 square kilometers” to the expression would not convey a sense of surprise.

For example, the information processing device 100 replaces a proper noun in a “combination of a proper noun and a quantitative expression” with another proper noun familiar to the user in accordance with the profile of the user.

As described above, the profile includes the name, age, sex, birth date, country of origin (nationality), place of origin, language used, current address, occupation, field of business, and hobbies, for example.

The units of quantity to be covered include the units of area, height, depth, speed, weight, illuminance, era, monetary value, and magnification, for example.

In the replacement of a proper noun, the proper noun may be replaced by a proper noun in a different field easier to understand for the user, if the proper noun is expressible in the same unit of quantity. In rephrasing “Oedo Dome” of “three times the size of Oedo Dome,” for example, the baseball stadium may be replaced by a soccer stadium of a size similar to that of the baseball stadium if soccer is a hobby of the user.

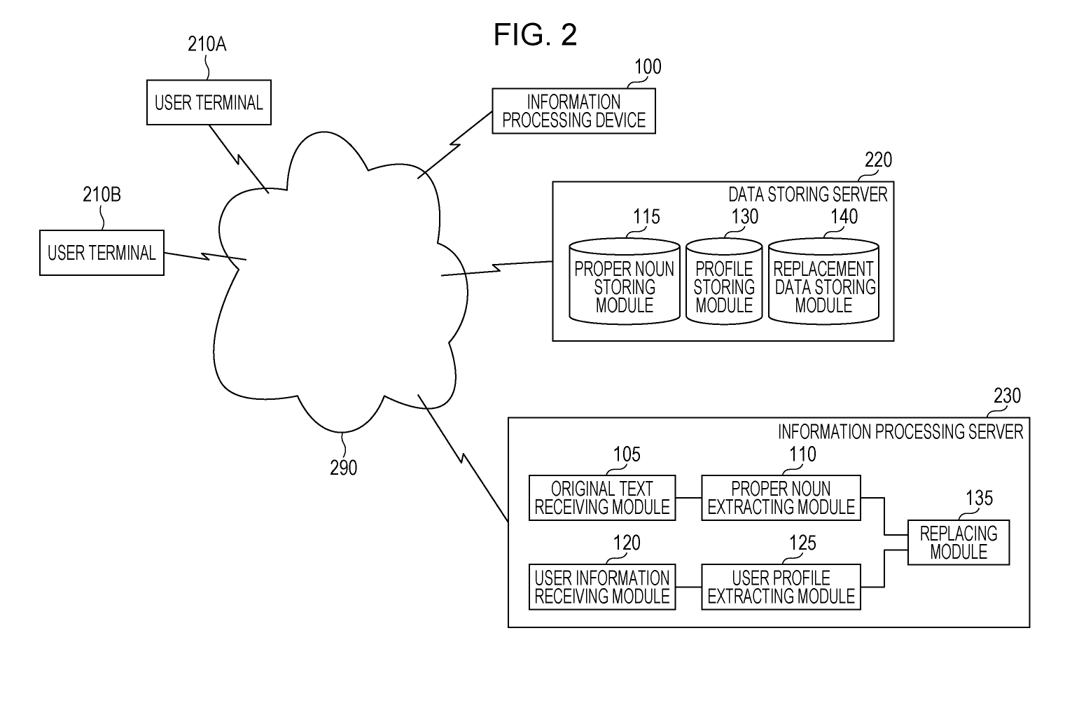

FIG. 2 is an explanatory diagram illustrating a system configuration example using the exemplary embodiment.

The information processing device 100, a user terminal 210A, a user terminal 210B, a data storing server 220, and an information processing server 230 are connected to one another via a communication line 290. The communication line 290 may be wireless, wired, or a combination thereof. For example, the communication line 290 may be the Internet or an intranet as a communication infrastructure. Further, the functions of the information processing device 100, the data storing server 220, and the information processing server 230 may be implemented as a cloud service.

For example, the information processing device 100 may receive the original text 103 from the user terminal 210A and return the replacement result 142 to the user terminal 210A.

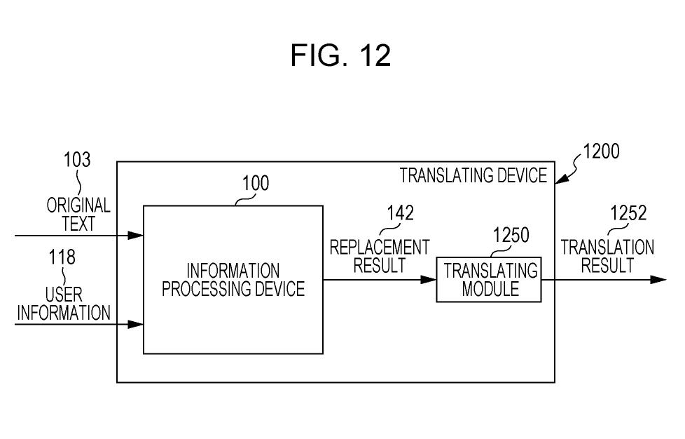

Further, if a translating device 1200 (see FIG. 12) of a second exemplary embodiment is employed in place of the information processing device 100, the translating device 1200 may receive the original text 103 from the user terminal 210A and return a translation result 1252 to the user terminal 210B.

Further, the functions of the information processing device 100 may be divided into the data storing server 220 and the information processing server 230. The data storing server 220 includes the proper noun storing module 115, the profile storing module 130, and the replacement data storing module 140. The data storing server 220 may manage the proper noun storing module 115, the profile storing module 130, and the replacement data storing module 140 to keep information therein up to date. Further, the information processing server 230 includes the original text receiving module 105, the proper noun extracting module 110, the user information receiving module 120, the user profile extracting module 125, and the replacing module 135. The information processing server 230 may use the proper noun storing module 115, the profile storing module 130, and the replacement data storing module 140 of the data storing server 220 to perform the replacement of a proper noun in the original text 103 and generate the replacement result 142.

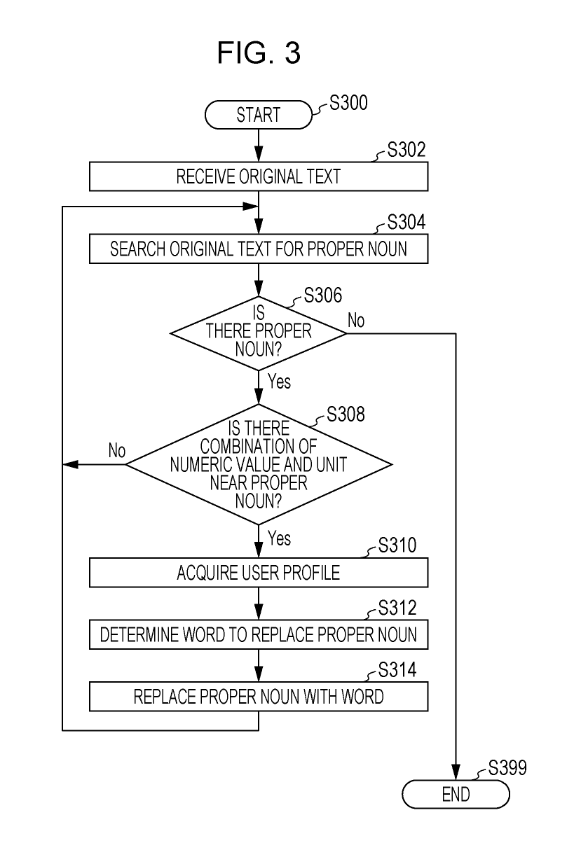

FIG. 3 is a flowchart illustrating a process example of the first exemplary embodiment.

At step S302, the original text receiving module 105 receives the original text 103.

At step S304, the proper noun extracting module 110 searches the original text 103 for a proper noun with the proper noun storing module 115.

At step S306, the replacing module 135 determines whether or not there is a proper noun. If there is a proper noun, the process proceeds to step S308. If there is no proper noun, the process is completed (step S399).

At step S308, the replacing module 135 determines whether or not there is a combination of a numeric value and a unit near the proper noun. If there is such a combination near the proper noun, the process proceeds to step S310. If there is not such a combination near the proper noun, the process returns to step S304.

At step S310, the user profile extracting module 125 acquires a user profile from the profile storing module 130.

At step S312, the replacing module 135 determines the word to replace the proper noun.

At step S314, the replacing module 135 replaces the proper noun with the word.

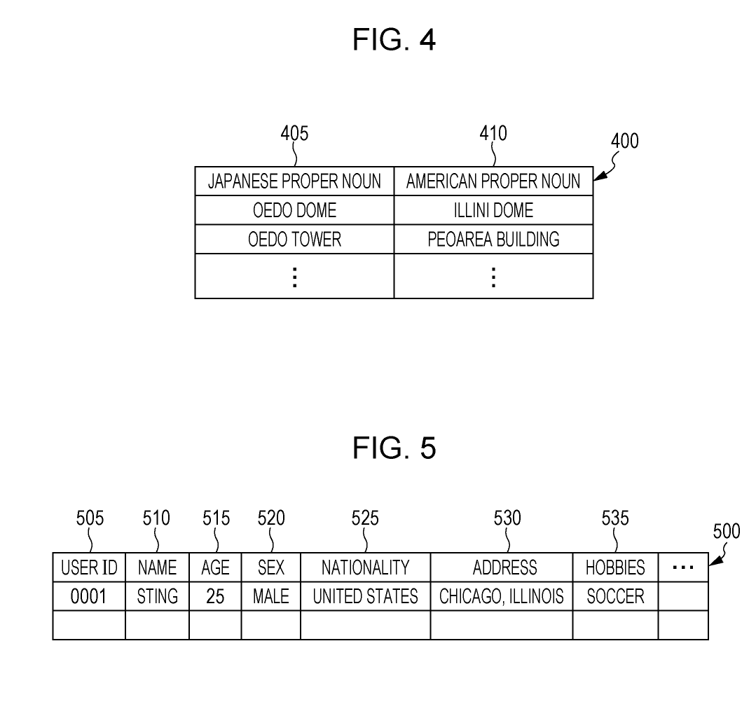

FIG. 4 is an explanatory diagram illustrating a data structure example of a proper noun pair table 400. The proper noun pair table 400 is stored in the replacement data storing module 140. The proper noun pair table 400 includes a Japanese proper noun field 405 and an American proper noun field 410. The Japanese proper noun field 405 stores Japanese proper nouns. The American proper noun field 410 stores American proper nouns (which may include nouns). In the example of FIG. 4, the proper noun pair table 400 stores pairs of proper nouns in Japan and corresponding proper nouns in the United States. The proper noun pair table 400, however, may store pairs in other countries, or may store pairs according to the profile. That is, the replacement data storing module 140 stores plural tables (proper noun pair tables 400) each storing pairs of proper nouns and replacement target nouns. The replacing module 135 may select one of these tables in accordance with the profile of the user. For example, if the profile of the user indicates that the nationality of the user is the United States, the replacing module 135 may select the corresponding proper noun pair table 400 from the replacement data storing module 140 and use the selected proper noun pair table 400 for the replacement.

Further, the proper noun storing module 115 may store the proper noun pair stable 400. That is, the proper noun pair stable 400 (one or both of the Japanese proper noun field 405 and the American proper noun field 410) may be used to extract a proper noun from the original text 103.

FIG. 5 is an explanatory diagram illustrating a data structure example of a profile table 500. The profile table 500 is stored in the profile storing module 130. The profile table 500 includes a user ID field 505, a name field 510, an age field 515, a sex field 520, a nationality field 525, an address field 530, and a hobby field 535. In the exemplary embodiment, the user ID field 505 stores information for uniquely identifying the user (user ID). The name field 510 stores the name of the user. The age field 515 stores the age of the user. The sex field 520 stores the sex of the user. The nationality field 525 stores the nationality of the user. The address field 530 stores the address of the user. The hobby field 535 stores a hobby of the user. With the user ID in the user information 118, the user profile extracting module 125 extracts the profile of the user, such as the sex and nationality of the user.

Then, the replacing module 135 performs the replacement process by selecting the proper noun pair table 400 according to the profile.

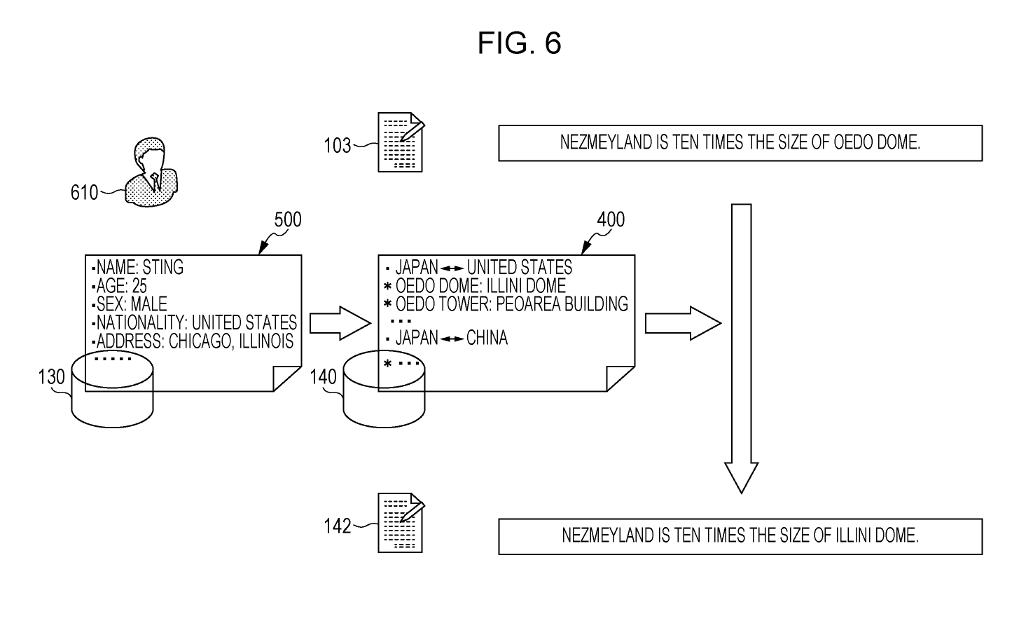

FIG. 6 is an explanatory diagram illustrating a process example according to the first exemplary embodiment, in which a “combination of a proper noun and a quantitative expression located near the proper noun” is replaced by a noun.

A description will be given of a process to be performed when a text “Nezmeyland is ten times the size of Oedo Dome.” is received as the original text 103 and the user is Mr. Sting 610. Herein, the original text 103 is assumed to have been known to be written in Japanese. For example, the receipt of the original text 103 written in Japanese may previously be known (predetermined), or the original text 103 may be determined to be written in Japanese from the character code used in the original text 103.

The proper noun extracting module 110 extracts “ten times the size of Oedo Dome” from the original text 103 as a “combination of a proper noun and a quantitative expression located near the proper noun.” For example, the proper noun extracting module 110 extracts proper nouns “Nezmeyland” and “Oedo Dome” from the original text 103 with the proper noun storing module 115. The proper noun extracting module 110 then selects a proper noun preceded or followed by a quantitative expression. Herein, “ten times” is a quantitative expression. Thus, “ten times the size of Oedo Dome” is extracted as a “combination of a proper noun and a quantitative expression located near the proper noun.”

Meanwhile, the user profile extracting module 125 extracts the profile table 500 of Mr. Sting 610, who is the user, from the profile storing module 130, and it is found that the nationality of Mr. Sting 610 is the “United States.” Therefore, the replacing module 135 selects the proper noun pair table 400 formed of pairs of Japanese proper nouns and American proper nouns, and extracts “Illini Dome” corresponding to “Oedo Dome.” The replacing module 135 replaces “Oedo Dome” in the original text 103 with “Illini Dome” to generate the text “Nezmeyland is ten times the size of Illini Dome” as the replacement result 142.

A noun having an attribute (area, for example) similar to that of the replacement source noun may be selected as the replacement target noun. Herein, the term “similar” means that the difference between the two nouns (the difference in area therebetween in this case) is within a predetermined value, or that the two nouns completely match each other. Herein, the area of “Oedo Dome” and the area of “Illini Dome” are similar to each other. Further, if the attribute of the replacement source noun and the attribute of the replacement target noun are not similar, the quantitative expression may be changed. That is, a quantitative expression B of the replacement target noun may be determined such that the product of the attribute (area, for example) and the quantitative expression B of the replacement target noun is similar (or equal) to the product of the attribute (area, for example) and a quantitative expression A of the replacement source noun. For example, if the replacement target noun represents a building or the like having an area half that of “Oedo Dome,” the quantitative expression “ten times” may be converted into “twenty times.”

Further, the proper noun pair table 400 may be replaced by a proper noun pair and attribute table 700.

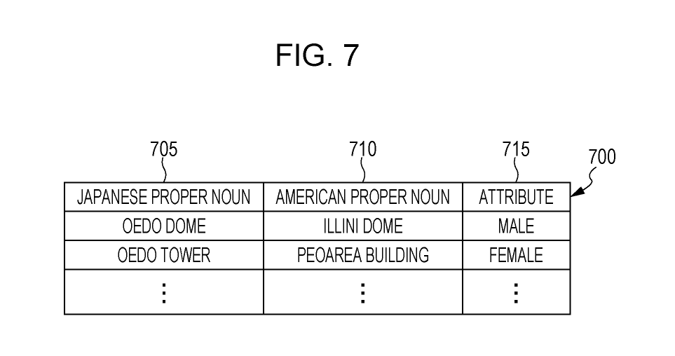

FIG. 7 is an explanatory diagram illustrating a data structure example of the proper noun pair and attribute table 700. The proper noun pair and attribute table 700 stores proper nouns, nouns, and information related to the user in association with one another, and includes a Japanese proper noun field 705, an American proper noun field 710, and an attribute field 715. The Japanese proper noun field 705 stores Japanese proper nouns. The American proper noun field 710 stores American proper nouns. The attribute field 715 stores attributes. That is, the proper noun pair and attribute table 700 corresponds to the proper noun pair table 400 added with the attribute field 715. For example, in the replacement of “Oedo Dome,” a replacement target noun having an attribute matching the profile (sex in this case) of the user may be selected. In the example of FIG. 6, Mr. Sting 610 is male. Thus, “Illini Dome” on the first row of the proper noun pair and attribute table 700 is selected as the replacement target. The attribute field 715 may be used if there are plural replacement targets corresponding to one replacement source.

Further, the replacing module 135 may perform the replacement process with a category tree.

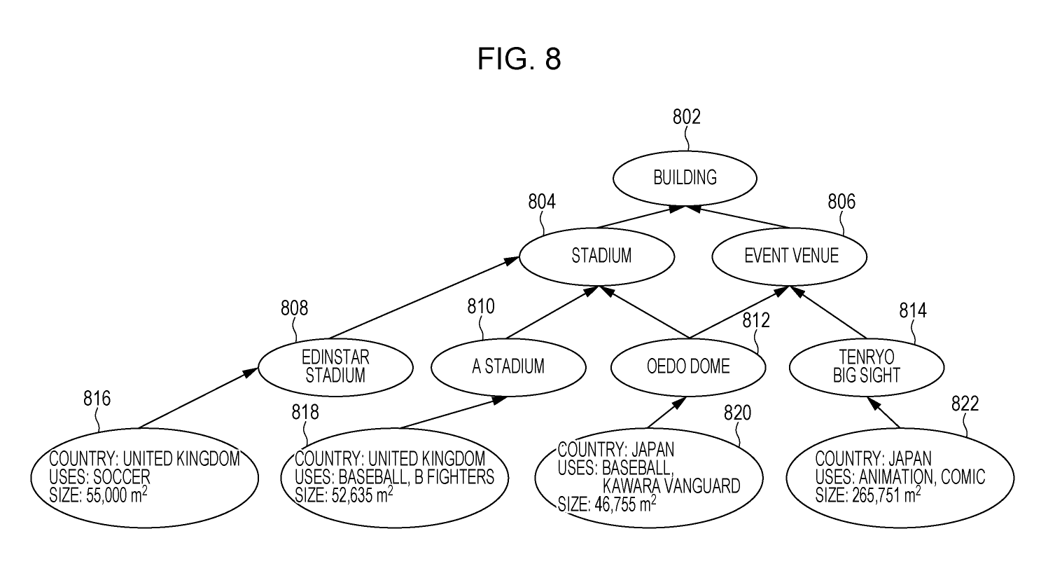

FIG. 8 is an explanatory diagram illustrating a data structure example of the category tree. A node (building) 802 has a node (stadium) 804 and a node (event venue) 806 thereunder, and the node (stadium) 804 has a node (Edinstar Stadium) 808, a node (A Stadium) 810, and a node (Oedo Dome) 812 thereunder. The node (event venue) 806 has the node (Oedo Dome) 812 and a node (Tenryo Big Sight) 814 thereunder. The node (Edinstar Stadium) 808 has a node (attributes) 816 thereunder, and the node (A Stadium) 810 has a node (attributes) 818 thereunder. The node (Oedo Dome) 812 has a node (attributes) 820 thereunder, and the node (Tenryo Big Sight) 814 has a node (attributes) 822 thereunder.

The node (building) 802, the node (stadium) 804, and the node (event venue) 806, which are the nodes on the first and second layers, indicate categories. The node (Edinstar Stadium) 808, the node (A Stadium) 810, the node (Oedo Dome) 812, and the node (Tenryo Big Sight) 814, which are the nodes on the third layer, indicate proper nouns. The node (attributes) 816, the node (attributes) 818, the node (attributes) 820, and the node (attributes) 822, which are the nodes on the fourth layer, indicate related profiles (attributes) of the proper nouns.

Pairs of the proper noun nodes (the nodes on the third layer) and the related profile nodes (the nodes on the fourth layer) may be implemented as a proper noun profile table 900.

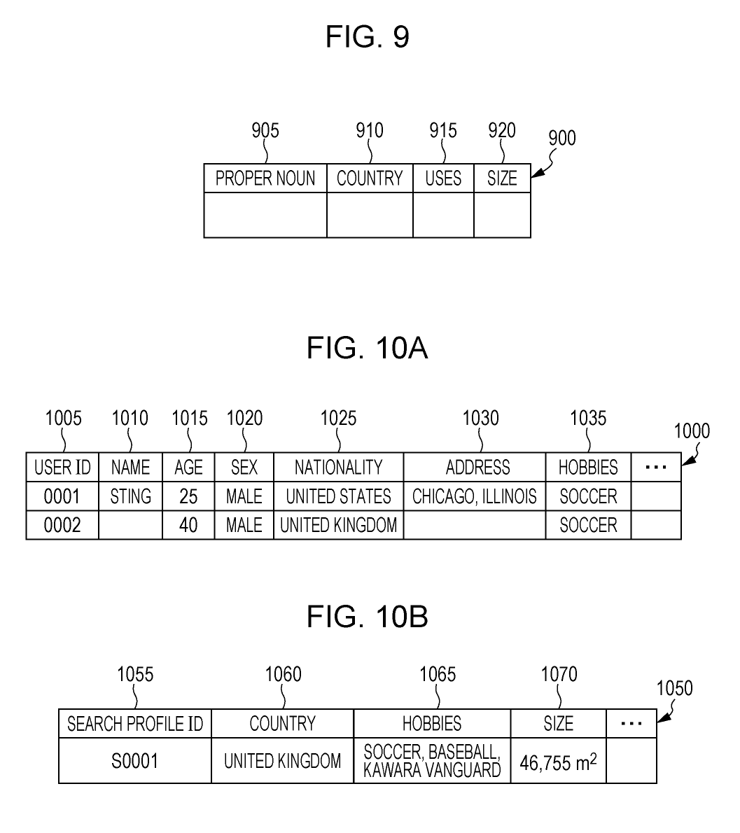

FIG. 9 is an explanatory diagram illustrating a data structure example of the proper noun profile table 900. The proper noun profile table 900 includes a proper noun field 905, a country field 910, a use field 915, and a size field 920. The proper noun field 905 stores a proper noun. The country field 910 stores the country in which the item represented by the proper noun is located. The use field 915 stores the use(s) of the item represented by the proper noun. The size field 920 stores the size of the item represented by the proper noun. The proper noun profile table 900 may further include other attributes (sex (frequently used by males), for example).

With the category tree illustrated in the example of FIG. 8, the replacing module 135 may perform the following process:

(1) The replacing module 135 searches the category tree for the node of the proper noun “Oedo Dome” as the replacement source, and extracts the attributes corresponding to the node. Specifically, the replacing module 135 extracts the node on the fourth layer connected to the node of “Oedo Dome.” The replacing module 135 then extracts a category including the node. Specifically, the replacing module 135 extracts a higher node connected to the node.

(2) The replacing module 135 creates a search profile from the extracted attributes, category, and user profile. For example, the extracted attributes, category, and user profile may be merged to create the search profile. The types of attributes to be merged are predetermined.

For example, the first row of a user profile table 1000 illustrated in FIG. 10A and the node (attributes) 820 may be merged to generate a search profile table 1050 illustrated in FIG. 10B. The data structure of the user profile table 1000 is equal to that of the profile table 500 illustrated in the example of FIG. 5. The search profile table 1050 includes a search profile ID field 1055, a country field 1060, a hobby field 1065, and a size field 1070. In the exemplary embodiment, the search profile ID field 1055 stores information for uniquely identifying the search profile (a search profile ID). The country field 1060 stores a country. The hobby field 1065 stores hobbies. The size field 1070 stores a size. The present example adopts a nationality field 1025 of the user profile table 1000 as the country field 1060, adopts both a hobby field 1035 of the user profile table 1000 and the use field 915 of the proper noun profile table 900 as the hobby field 1065, and adopts the size field 920 of the proper noun profile table 900 as the size field 1070.

(3) The replacing module 135 may return to a higher node including thereunder the replacement source node (Oedo Dome) 812 in the category tree, and select the replacement target noun (node) in accordance with the degree of match between the attributes of each node located under the higher node (node on the fourth layer) and the search profile table 1050.

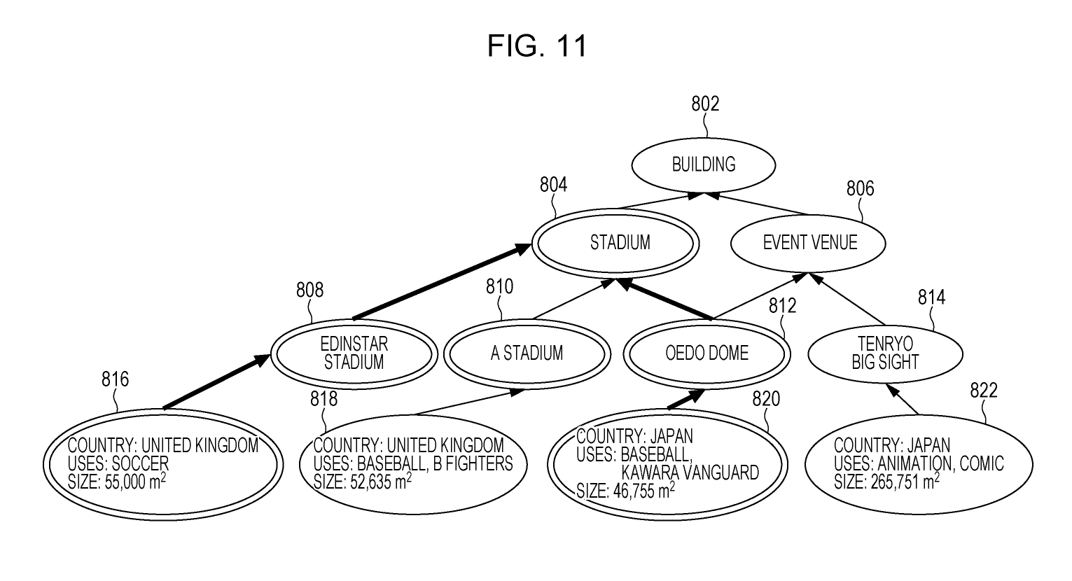

Specifically, as indicated by thick arrows in the category tree illustrated in the example of FIG. 11, the replacing module 135 may return to the node (stadium) 804 immediately above the node (Oedo Dome) 812, and compare the search profile (the search profile table 1050) with the attributes (the node (attributes) 816 or the node (attributes) 818) of a node located under the node (stadium) 804 (the node (Edinstar Stadium) 808 or the node (A Stadium) 810). Herein, the respective nouns of the node (Edinstar Stadium) 808 and the node (A Stadium) 810 are similar to the category of the node (stadium) 804. This is because the node (Edinstar Stadium) 808 and the node (A Stadium) 810 share the same higher node (stadium) 804. If the degree of match of a noun (of a node on the third layer) resulting from the comparison is equal to or greater than a predetermined threshold, the noun is determined as the replacement target noun. For example, if the degree of match of the node (attributes) 816 with the search profile table 1050 is equal to or greater than the predetermined threshold, “Edinstar Stadium” of the node (Edinstar Stadium) 808 is selected as the replacement target noun.

Herein, the degree of match may be the ratio of the number of matched items to the number of all items in the attributes (the node (attributes) 816 or the node (attributes) 818) and the search profile (the search profile table 1050). Herein, “the number of matched items” specifically refers to the number of matched fields in the search profile table 1050, and “the number of all items” specifically refers to the number of all fields in the search profile table 1050.

If there is no noun having a degree of match equal to or greater than the predetermined threshold, the replacing module 135 returns to a further higher node to include nodes thereunder as search targets. In the example illustrated in FIG. 11, the replacing module 135 returns to the node (building) 802 higher than the node (stadium) 804 to include, as the search targets, the nodes under the node (event venue) 806, which is lower than the node (building) 802.

Further, if there is no noun having a degree of match equal to or greater than the predetermined threshold even after returning to a higher node in the route of the category tree, the replacing module 135 does not perform the replacement.

### Second Exemplary Embodiment

FIG. 12 is a conceptual module configuration diagram of a configuration example of the second exemplary embodiment. In the second exemplary embodiment, the processing result (replacement result 142) of the first exemplary embodiment is translated. Since a proper noun has been changed into a noun used in the translation target language, the use of an appropriate noun in the translation target language is possible through a general translation process. That is, even a proper noun difficult to translate has previously been changed into a noun in the translation target language, allowing the translation of such a proper noun.

Parts similar in type to those of the first exemplary embodiment are assigned with the same reference numerals, and redundant description thereof will be omitted. Further, in the system configuration example illustrated in FIG. 2, the information processing device 100 may be replaced by the translating device 1200, or the translating device 1200 may be added to the system configuration example to be communicable with the communication line 290.

The translating device 1200 includes the information processing device 100 and a translating module 1250.

The information processing device 100, which is connected to the translating module 1250, receives the original text 103 and the user information 118 and transmits the replacement result 142 to the translating module 1250.

The original text receiving module 105 of the information processing device 100 may receive a sentence described in a first language (a translation source language).

The translating module 1250, which is connected to the information processing device 100, receives the replacement result 142 from the information processing device 100 and outputs the translation result 1252. The translating module 1250 translates the sentence (the replacement result 142) subjected to the proper noun replacement by the information processing device 100 (the replacing module 135) into a second language different from the first language and used by the user (a translation target language). The translation process may employ a known translation process.

The replacement and translation of a “proper noun” or a “combination of a proper noun and a quantitative expression” by the translating device 1200 enables conversion of a noun into a noun suitable for the user of the translation result 1252, thereby allowing a relative or emotive expression of a quantity based on the knowledge and experience of the user, who is the reader of the translation result 1252.

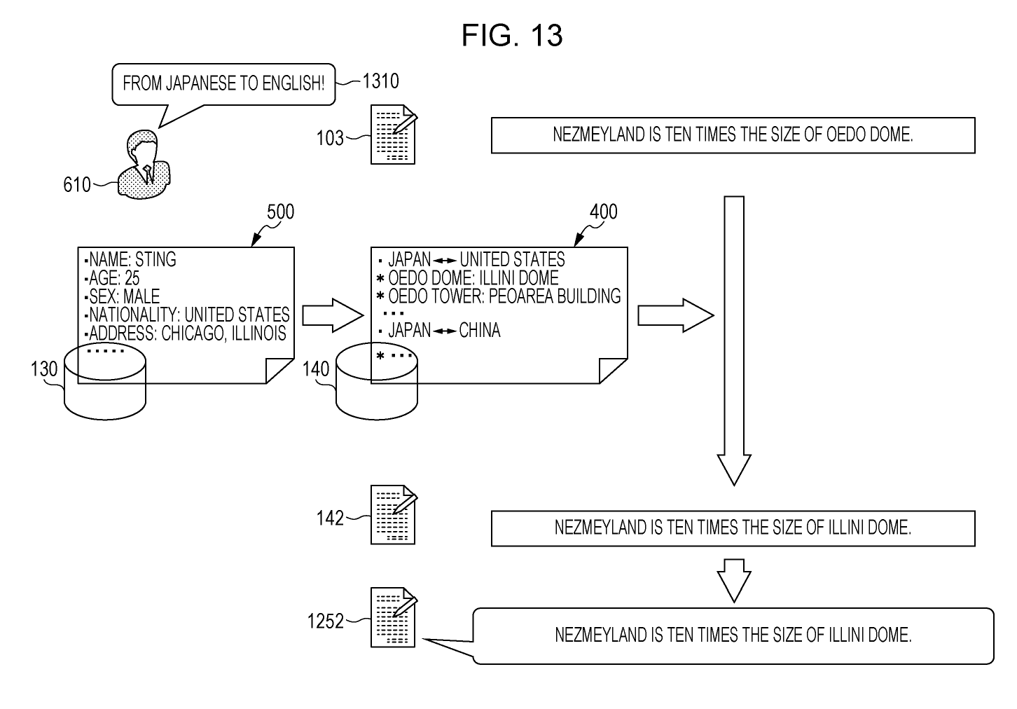

FIG. 13 is an explanatory diagram illustrating a process example of the second exemplary embodiment and corresponding to the example of FIG. 6. In accordance with an instruction 1310 (“From Japanese to English!”) from Mr. Sting 610, the replacement result 142 is translated into the translation result 1252 “Nezmeyland is ten times the size of Illini Dome.”

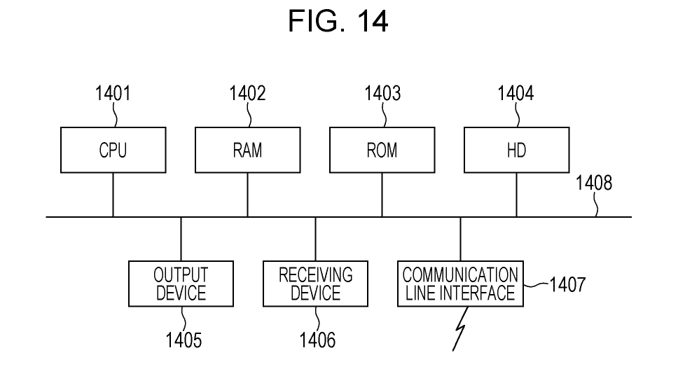

As illustrated in the example of FIG. 14, a computer that executes programs of the exemplary embodiments has the hardware configuration of a general computer. Specifically, the computer is a personal computer or a computer capable of serving as a server, for example. That is, as a specific example, the computer uses a CPU 1401 as a processing unit (arithmetic unit), and uses a RAM 1402, a read-only memory (ROM) 1403, and a hard disk (HD) 1404 as storage devices. For example, a hard disk or a solid state drive (SSD) may be employed as the HD 1404. The computer is configured by the CPU 1401, the RAM 1402, the ROM 1403, the HD 1404, a receiving device 1406, an output device 1405, a communication line interface 1407, and a bus 1408. The CPU 1401 executes a program such as the original text receiving module 105, the proper noun extracting module 110, the user information receiving module 120, the user profile extracting module 125, the replacing module 135, and the translating module 1250. The RAM 1402 stores the program and data. The ROM 1403 stores, for example, a program for starting the computer. The HD 1404 is an auxiliary storage device (which may be a device such as a flash memory) having the functions of the proper noun storing module 115, the profile storing module 130, and the replacement data storing module 140. The receiving device 1406 receives data based on an operation performed by the user on devices such as a keyboard, a mouse, a touch screen, and a microphone. The output device 1405 includes devices such as a cathode-ray tube (CRT), a liquid crystal display, and a speaker. The communication line interface 1407, such as a network interface card, connects the computer to a communication network. The bus 1408 connects the above-described units to exchange data therebetween. Plural computers each having these units may be mutually connected by a network.

Any of the foregoing exemplary embodiments based on a computer program is implemented when the computer program as software is read by the system of the present hardware configuration and the software and hardware resources cooperate with each other.

The hardware configuration illustrated in FIG. 14 illustrates one configuration example. The exemplary embodiment is not limited to the configuration illustrated in FIG. 14, and may have any configuration capable of executing the modules described in the exemplary embodiments. For example, some of the modules may be configured by dedicated hardware (an application specific integrated circuit (ASIC), for example), or may be located in an external system and connected to the rest of the modules by a communication line. Further, plural systems each having the configuration illustrated in FIG. 14 may be mutually connected by a communication line to cooperate with one another. Further, as well as in a personal computer, the hardware configuration may specifically be incorporated in a mobile information communication device (which includes a mobile phone, a smartphone, a mobile device, and a wearable computer), a home information appliance, a robot, a copier, a facsimile machine, a scanner, a printer, or a multifunction peripheral (an image processing apparatus having the functions of at least two of a scanner, a printer, a copier, and a facsimile machine, for example).

Further, in the comparison process described in the foregoing exemplary embodiments, the expressions “equal to or greater than,” “equal to or smaller (less) than,” “greater than,” and “smaller (less) than” may be understood as “greater than,” “smaller (less) than,” “equal to or greater than,” and “equal to or smaller (less) than,” respectively, unless a contradiction arises in the combinations of words.

The program described above may be provided as stored in a recording medium, or may be provided via a communication unit. In that case, the program described above may be understood as an invention of a “computer-readable recording medium recording a program,” for example.

The “computer-readable recording medium recording a program” refers to a recording medium recording a program, readable by a computer, and used for purposes such as the installation, execution, and distribution of a program.

The recording medium includes, for example, digital versatile discs (DVDs) complying with standards set by the DVD Forum, such as a DVD-recordable (R), a DVD-rewritable (DVD-RW), and a DVD-RAM, DVDs complying with standards set by the DVD+RW, such as a DVD+R and a DVD+RW, compact discs (CDs) such as a CD-ROM, a CD-R, and a CD-RW, a Blu-ray (registered trademark) disc, a magneto-optical (MO) disc, a flexible disc (FD), a magnetic tape, a hard disk, a ROM, an electrically erasable programmable ROM (EEPROM: registered trademark), a flash memory, a RAM, and a secure digital (SD) memory card.

Further, all or a part of the foregoing program may be stored or distributed, for example, as recorded in the foregoing recording medium. Further, the program may be transmitted by communication with a transmission medium such as a wired network, a wireless communication network, or a combination thereof, which is used in a local area network (LAN), a metropolitan area network (MAN), a wide area network (WAN), the Internet, an intranet, or an extranet, for example, or may be carried on carrier waves.

Further, the foregoing program may be a part or all of another program, or may be recorded in a recording medium together with another program. Further, the program may be recorded as divided into plural recording media. Further, the program may be recorded in any restorable form, such as a compressed or encoded form.

The foregoing description of the exemplary embodiments of the present invention has been provided for the uses of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
a receiving unit that receives a sentence containing at least a proper noun;
an acquiring unit that acquires information related to a user who uses a sentence processed by the information processing device; and
a replacing unit that replaces the proper noun with another noun by using the information related to the user.

2. The information processing device according to claim 1, wherein the replacing unit replaces the proper noun with the another noun in accordance with a language used by the user.

3. The information processing device according to claim 2, wherein the sentence received by the receiving unit is described in a first language,
wherein the information processing device further comprises a translating unit that translates the sentence having the replaced proper noun into a second language different from the first language and used by the user.

4. The information processing device according to claim 1, wherein the replacing unit replaces the proper noun with the another noun by using a memory in which the proper noun, the another noun, and the information related to the user are stored in association with one another.

5. The information processing device according to claim 1, wherein the replacing unit replaces the proper noun with the another noun by comparing the information related to the user with information related to a noun similar to the proper noun.

6. The information processing device according to claim 4, wherein the replacing unit changes the another noun into a currently used noun.

7. The information processing device according to claim 5, wherein the replacing unit changes the another noun into a currently used noun.

8. The information processing device according to claim 1, wherein the proper noun is a combination of a proper noun and a quantitative expression located near the proper noun.

9. The information processing device according to claim 2, wherein the proper noun is a combination of a proper noun and a quantitative expression located near the proper noun.

10. The information processing device according to claim 3, wherein the proper noun is a combination of a proper noun and a quantitative expression located near the proper noun.

11. The information processing device according to claim 4, wherein the proper noun is a combination of a proper noun and a quantitative expression located near the proper noun.

12. The information processing device according to claim 5, wherein the proper noun is a combination of a proper noun and a quantitative expression located near the proper noun.

13. The information processing device according to claim 6, wherein the proper noun is a combination of a proper noun and a quantitative expression located near the proper noun.

14. The information processing device according to claim 7, wherein the proper noun is a combination of a proper noun and a quantitative expression located near the proper noun.

15. A non-transitory computer readable medium storing a program causing a computer being an information processing device to execute a process for information processing, the process comprising:
receiving a sentence containing at least a proper noun;
acquiring information related to a user who uses a sentence processed by the information processing device; and
replacing the proper noun with another noun by using the information related to the user.
